(19) United States
(12) Patent Application Publication
(10) Pub. No.: US 2025/0202069 A1
(43) Pub. Date: Jun. 19, 2025

(54) BATTERY MODULE AND REPAIRING METHOD THEREFOR

(71) Applicant: Trend Power Technology(changshu) Inc., Jiansu Province (CN)

(72) Inventors: Chia-Chun CHANG, Zhubei City (TW); Chih-Chiang LIU, Hsinchu County (TW); Chao-Kai WANG, Hsinchu County (TW)

(21) Appl. No.: 18/985,547

(22) Filed: Dec. 18, 2024

(30) Foreign Application Priority Data
Dec. 19, 2023 (CN) 2023117498865

(51) Int. Cl. H01M 50/514; H01M 10/42; H01M 50/244; H01M 50/262; H01M 50/519; H01M 50/569

(52) U.S. Cl. CPC H01M 50/514; H01M 10/4207; H01M 50/244; H01M 50/262; H01M 50/519; H01M 50/569

(57) ABSTRACT

A battery module includes a housing, an outer cover, cell assemblies, a circuit board, connecting wires and conductive assemblies. The housing includes a top plate and two side plates respectively connected with opposite sides thereof. The side plates respectively includes hollow windows arranged along a direction. The outer cover covers the two side plates and forms a chamber with the housing. Cell assemblies are arranged in the chamber along the direction. The circuit board is arranged on the top plate. Connecting wires are electrically connected with the circuit board and cell assemblies. Conductive assemblies correspond to the positions of hollow windows and are electrically connected with two adjacent cell assemblies among cell assemblies. An abnormal or damaged cell assembly can be replaced by disassembling the battery module, while the normal cell assemblies keep in use, meeting the needs in recycling and repairing.

### BACKGROUND OF THE INVENTION

This application claims priority for the CN patent application No. 2023117498865 filed on 19 Dec. 2023, the content of which is incorporated by reference in its entirely.

### FIELD OF THE INVENTION

The disclosure relates to a battery module and a repairing method for the battery module.

### DESCRIPTION OF THE PRIOR ART

With the increasing demands for environmental protection driven by corporate social responsibility and the green industry, the need for reusability of battery modules is also growing. The current structure and connection method of battery modules require a lot of time to disassemble and assemble before repair or replacement, making them difficult to reuse. Therefore, a reusable battery module is urgently needed.

### SUMMARY OF THE INVENTION

The disclosure provides a battery module. The battery module includes a housing, an outer cover, a plurality of cell assemblies, a circuit board, a plurality of connecting wires, and a plurality of conductive assemblies. The housing includes a top plate and two side plates respectively connected with opposite sides of the top plate. Each of the side plates includes a plurality of hollow windows arranged along a direction. The outer cover covers the two side plates and forms a chamber with the housing. The plurality of cell assemblies are arranged in the chamber along the direction. The circuit board is arranged on the top plate. The plurality of connecting wires is electrically connected with the circuit board and the plurality of cell assemblies. The plurality of conductive assemblies correspond to the positions of the plurality of hollow windows and are electrically connected with two adjacent cell assemblies among the plurality of cell assemblies.

In some embodiments, the plurality of connecting wires pass through the plurality of hollow windows respectively to be electrically connected with the circuit board and the plurality of cell assemblies.

In some embodiments, a top portion of each of the cell assemblies includes a positioning protrusion, and the top plate of the housing includes a plurality of positioning holes for respectively accommodating the plurality of positioning protrusions.

In some embodiments, each of the conductive assemblies includes a busbar and two fixing members. Both ends of the busbar are provided with a through hole respectively. Two fixing members are used to lock the busbar to the two adjacent cell assemblies through the two through holes.

In some embodiments, the plurality of connecting wires passes through the plurality of fixing members respectively to be electrically connected with the plurality of cell assemblies.

In some embodiments, each of the cell assemblies includes a cell support and two conductive sheets. The cell support is accommodated with a plurality of cells. The two conductive sheets are respectively arranged on two sides of the cell support and are electrically connected with both ends of the plurality of cells. The through hole passes through the conductive sheet and the cell support. Each of the fixing members is locked on the cell support through the through hole and is electrically connected with the busbar and the conductive sheet.

In some embodiments, the battery module further includes a fixing post that passes through the housing and the cell assembly and is used to fix the cell assembly between the two side plates.

The disclosure provides a repairing method for the battery module. The repairing method for the battery module includes steps of: detecting abnormal cell assemblies among the plurality of cell assemblies; removing the outer cover; removing the connecting wire and the conductive assembly connected with the abnormal cell assembly; and placing a replacement cell assembly after the abnormal cell assembly is taken out from the chamber.

In some embodiments, the repairing method for the battery module further includes finding abnormal cells among a plurality of cells of the abnormal cell assemblies; and replacing the abnormal cell with a replacement cell to form the replacement cell assembly.

In some embodiments, the repairing method for the battery module further includes steps of: connecting the connecting wire with the replacement cell assembly; connecting the conductive assembly with the replacement cell assembly; and locking the outer cover to the housing.

In some embodiments, the battery module further includes a fixing post that passes through the housing and the abnormal cell assembly for fixing the abnormal cell assembly between the two side plates. The repairing method for the battery module further includes removing the fixing post before the abnormal cell assembly is separately taken out from the chamber and the replacement cell assembly is placed.

It should be understood that both the foregoing general description and the following detailed description are exemplary and explanatory only and are intended to provide further explanation of the disclosure as claimed.

### BRIEF DESCRIPTION OF THE DRA WINGS

The disclosure may be more fully understood by reading the following detailed description of the embodiments and referring to the accompanying drawings.

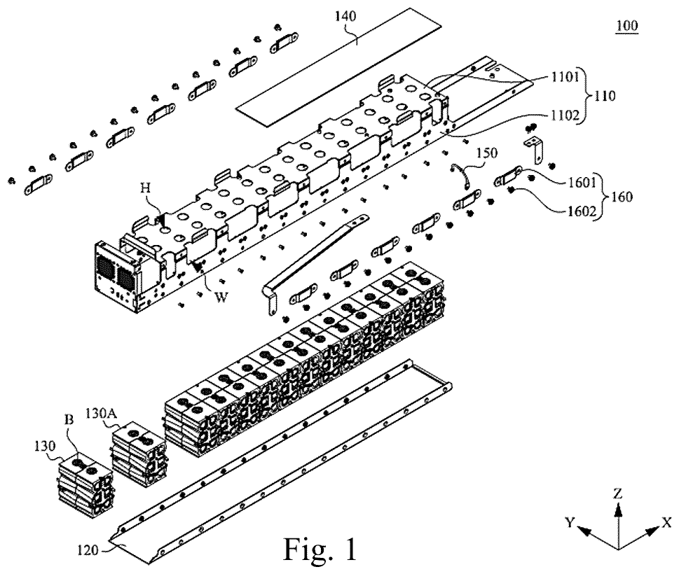

FIG. 1 is an exploded view of a battery module according to some embodiments of the disclosure.

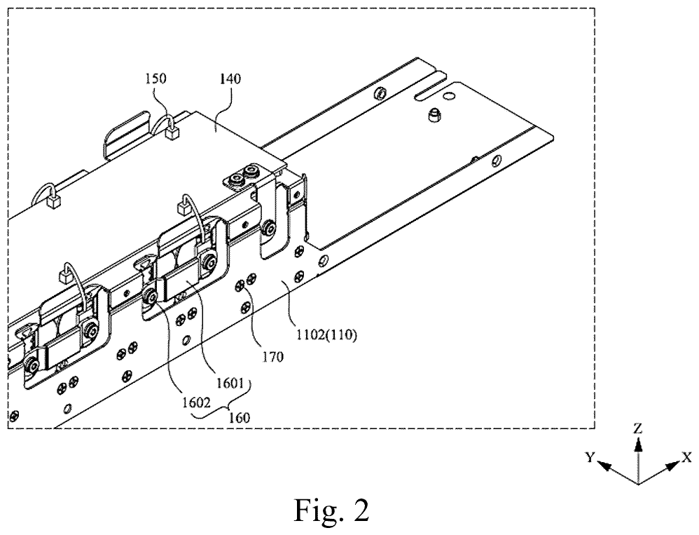

FIG. 2 is a partial three-dimensional view of the battery module according to some embodiments of the disclosure.

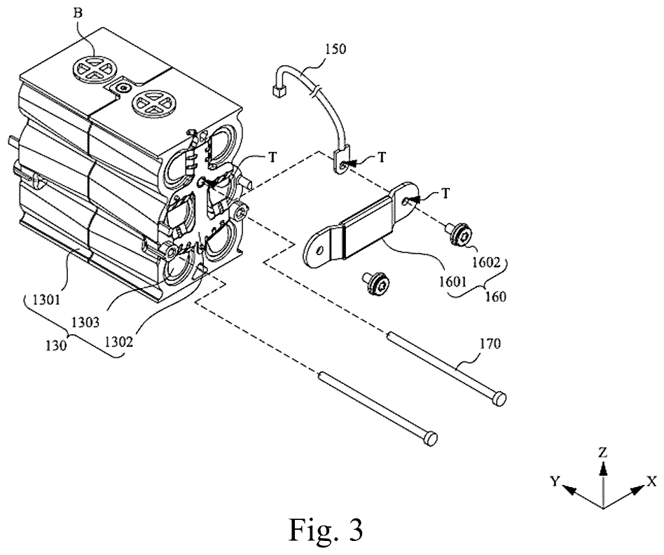

FIG. 3 is an exploded view of a cell assembly, a connecting wire, a conductive assembly, and a fixing post according to some embodiments of the disclosure.

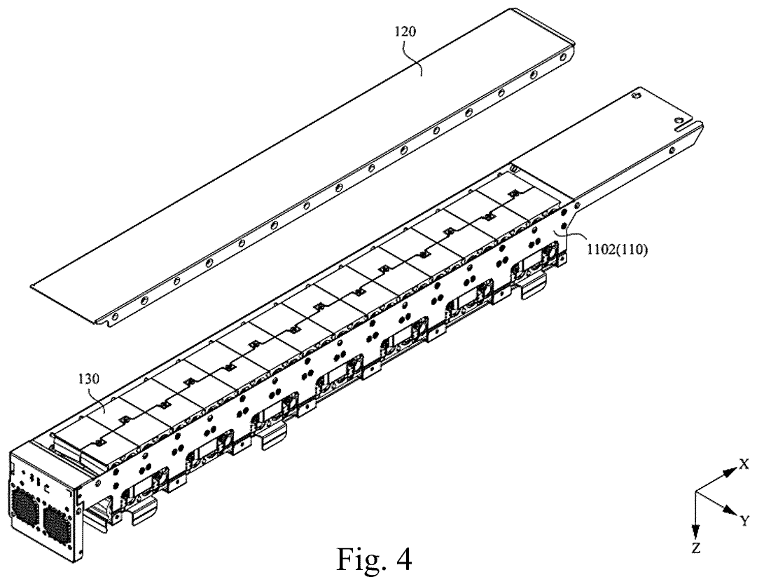

FIG. 4 is a three-dimensional view of a housing, an outer cover, and the cell assembly according to some embodiments of the disclosure.

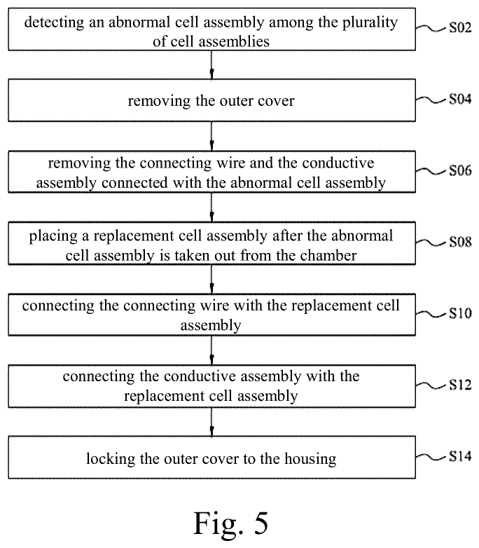

FIG. 5 is a flow chart of a repairing method for the battery module according to some embodiments of the disclosure.

### DESCRIPTION OF THE PREFERRED EMBODIMENTS

The following will disclose multiple implementations of the disclosure with reference to the accompanying drawings. For the purpose of clear description, many practical details will be described together in the following description. However, it should be understood that these practical details should not be used to limit the disclosure. That is to say, in some embodiments of the disclosure, these practical details are unnecessary. In addition, in order to simplify the drawings, some conventional structures and assemblies will be shown in the drawings in a simple schematic way. In addition, for the convenience of readers, the sizes of the components in the drawings are not drawn according to the actual scale.

Existing battery modules usually take a lot of time to repair or replace abnormal cells in the battery module. The repair process is also prone to component damage or short circuits, making the existing battery module difficult to repair or reuse, and the entire battery module needs to be replaced, which is not environmentally friendly and not economically efficient. In view of the above description, the disclosure provides a battery module. The battery module includes a housing, an outer cover, a plurality of cell assemblies, a circuit board, a plurality of connecting wires, and a plurality of conductive assemblies. The housing includes a top plate and two side plates respectively connected with opposite sides of the top plate. Each of the side plates includes a plurality of hollow windows arranged along a direction. The outer cover covers the two side plates and forms a chamber with the housing. The plurality of cell assemblies is arranged in the chamber along the direction. The circuit board is arranged on the top plate. The plurality of connecting wires is electrically connected with the circuit board and the plurality of cell assemblies. The conductive assemblies correspond to the positions of the plurality of hollow windows and are electrically connected with two adjacent cell assemblies among the plurality of cell assemblies. When one or more cell assemblies in the battery module are abnormal or damaged, the battery module can be disassembled and only the abnormal or damaged cell assemblies can be taken out and replaced, while the normal cell assemblies can be kept in the battery module for continued use, thus meeting the needs in recycling and repairing the battery module. The battery module and the repairing method for the battery module of the disclosure will be described below with reference to the accompanying drawings.

With reference to FIGS. 1 and 2, FIG. 1 is an exploded view of a battery module 100 according to some embodiments of the disclosure; FIG. 2 is a partial three-dimensional view of the battery module 100 according to some embodiments of the disclosure. As shown in FIG. 1, the battery module 100 includes a housing 110, an outer cover 120, a plurality of cell assemblies 130, a circuit board 140, a plurality of connecting wires 150, and a plurality of conductive assemblies 160. The housing 110 includes a top plate 1101 and two side plates 1102 respectively connected with opposite sides of the top plate 1101. Each of the side plates 1102 includes a plurality of hollow windows W arranged along a direction (X direction).

The outer cover 120 covers the two side plates 1102 and forms a chamber with the housing 110. The plurality of cell assemblies 130 are arranged in the chamber along the direction (X direction). As shown in FIG. 2, the circuit board 140 is arranged on the top plate 1101. The plurality of connecting wires 150 are electrically connected with the circuit board 140 and the plurality of cell assemblies 130. The plurality of conductive assemblies 160 correspond to the positions of the plurality of hollow windows and are electrically connected with two adjacent cell assemblies 130 among the plurality of cell assemblies 130. It should be noted that the housing 110 and the outer cover 120 are used to accommodate the plurality of cell assemblies 130 and provide overall structural strength and insulation capability for the battery module 100. The top plate 1101 of the housing 110 also provides a flat structural surface for arranging the circuit board 140. The plurality of cell assemblies 130 are connected in series or in parallel via the conductive assembly 160. The circuit board 140 detects the voltage of the cell assembly 130 through the connecting wire 150. It should be noted that when one or more of the cell assemblies 130 in the battery module 100 is abnormal or damaged, the conductive assembly 160 connected with the abnormal cell assembly 130A may be disassembled through the hollow window W to release the connection between the abnormal cell assembly 130A and two adjacent cell assemblies 130, the outer cover 120 and the connecting wire 150 may be removed, and the abnormal cell assembly 130A may then be taken out and replaced separately, while the normal cell assembly 130 may be kept in the battery module 100 and continue to be used. In this way, the entire battery module 100 does not need to be replaced, so that the battery module 100 may be repaired and reused.

With continuous reference to FIG. 1, the number of the hollow windows W, the cell assemblies 130, the connecting wires 150 and the conductive assemblies 160 is not limited to that shown in the figure. In some embodiments, the conductive assembly 160 may be made of a conductive material such as metal, more specifically copper and nickel. In some embodiments, the housing 110 and the outer cover 120 may be made of plastic.

With continuous reference to FIG. 1, in some embodiments, a top portion of each of the cell assemblies 130 (in Z direction) includes a positioning protrusion B, and the top plate 1101 of the housing 110 includes a plurality of positioning holes H for respectively accommodating the plurality of positioning protrusions B, so that the cell assembly 130 may be arranged stably in the housing 110.

With continuous reference to FIG. 1, in some embodiments, the battery module further includes a plurality of hooks or embedded components for locking the circuit board 140 onto the top plate 1101 of the housing 110, or for locking the outer cover 120 onto the two side plates 1102 of the housing 110.

With reference to FIGS. 1 and 2, in some embodiments, the plurality of connecting wires 150 pass through the plurality of hollow windows W respectively to be electrically connected with the circuit board 140 and the plurality of cell assemblies 130. When one or more of the cell assemblies 130 in the battery module 100 is abnormal or damaged, the connecting wire 150 connected with the abnormal cell assembly 130A may be disassembled through the hollow window W to release the connection between the abnormal cell assembly 130A and the circuit board 140 without disassembling the entire circuit board 140. This can prevent the circuit board 140 from being short-circuited or damaged during the disassembly process.

With reference to FIGS. 1 and 3, FIG. 3 is an exploded view of a cell assembly 130, a connecting wire 150, a conductive assembly 160, and a fixing post 170 according to some embodiments of the disclosure. The structure of the abnormal cell assembly 130A may refer to the structure of the cell assembly 130 (as shown in FIG. 3). In some embodiments, each of the conductive assemblies 160 includes a busbar 1601 and two fixing members 1602. Both ends of the busbar 1601 (in X direction) are provided with a through hole T respectively. Two fixing members 1602 are used to lock the busbar 1601 (in Y direction) to (in X direction) the two adjacent cell assemblies 130 through the two through holes T. When one or more of the cell assemblies 130 in the battery module 100 is abnormal or damaged, the busbar 1601 and the fixing member 1602 connected with the abnormal cell assembly 130A may be disassembled to release the connection between the abnormal cell assembly 130A and two adjacent cell assemblies 130, so that the abnormal cell assembly 130A may be taken out separately.

With reference to FIG. 3, in some embodiments, each of the cell assemblies 130 includes a cell support 1301 and two conductive sheets 1302. The cell support 1301 is accommodated with a plurality of cells 1303. The number of the cells 1303 is not limited to that shown in the figure. A long axis of the cell 1303 extends along the Y direction. The two conductive sheets 1302 are respectively arranged on two sides of the cell support 1301 and are electrically connected with both ends of the plurality of cells 1303 (i.e., positive electrode or negative electrode). The through hole T (in Y direction) passes through the conductive sheet 1302 and the cell support 1301. Each of the fixing members 1602 is locked on the cell support 1301 through the through hole T and is electrically connected with the busbar 1601 and the conductive sheet 1302. When one or more cells 1303 in the cell assembly 130 are abnormal or damaged, the fixing member 1602 may be disassembled to release the connection between the conductive sheet 1302 and the cell support 1301, so that the cell 1303 accommodated in the cell support 1301 may be taken out.

With reference to FIGS. 1 and 3, in some embodiments, the plurality of connecting wires 150 pass through the plurality of fixing members 1602 respectively to be electrically connected with the plurality of cell assemblies 130. When one or more of the cell assemblies 130 in the battery module 100 is abnormal or damaged, the fixing member 1602 connected with the abnormal cell assembly 130A may be disassembled to release the connection between the abnormal cell assembly 130A and the connecting wire 150.

With reference to FIGS. 3 and 2, in some embodiments, the battery module 100 further includes (in Y direction) a fixing post 170 that passes through the housing 110 and the cell assembly for fixing the cell assembly 130 between the two side plates 1102, so that the cell assembly 130 may be stably arranged in the housing 110.

With reference to FIGS. 1 and 4, FIG. 4 is a three-dimensional view of a housing 110, an outer cover 120, and the cell assembly 130 according to some embodiments of the disclosure. FIG. 4 is a bottom-up perspective of FIG. 1. When the battery module 100 is assembled, the housing 110 may be placed with an opening facing upward, the plurality of cell assemblies 130 may be placed in the housing 110, and then the outer cover 120 may be closed. In some embodiments, when one or more of the cell assemblies 130 in the battery module 100 is abnormal or damaged, the opening of the housing 110 may be placed upward, the outer cover 120 may be removed, and the conductive assemblies 160 and the connecting wires 150 connected with the abnormal cell assembly 130A may be disassembled to remove the abnormal cell assembly 130A separately.

The disclosure provides a repairing method for the battery module. Although the methods disclosed herein are described below using a series of operations or steps, the order in which these operations or steps are presented should not be construed as a limitation of the disclosure. For example, some operations or steps may be performed in a different order and/or concurrently with other steps. Furthermore, not all illustrated operations, steps and/or features must be performed to implement the embodiments of the disclosure. Furthermore, each operation or step described herein may include several sub-steps or actions.

With reference to FIGS. 5 and 1, FIG. 5 is a flow chart of a repairing method for the battery module 100 according to some embodiments of the disclosure. The repairing method for the battery module 100 includes steps from S02 to S14. In the step S02, abnormal cell assemblies 130A are detected among the plurality of cell assemblies 130. In the step S04, the outer cover 120 is removed. In the step S06, the connecting wire 150 and the conductive assembly 160 connected with the abnormal cell assembly 130A are removed. In the step S08, a replacement cell assembly is placed after the abnormal cell assembly 130A is taken out from the chamber. It should be noted that when one or more of the cell assemblies 130 in the battery module 100 is abnormal or damaged, the abnormal cell assembly 130A may then be taken out and replaced separately, while the normal cell assembly 130 may be kept in the battery module 100 and continue to be used. In this way, the entire battery module 100 does not need to be replaced, so that the battery module 100 may be repaired and reused. In some embodiments, the step S02, the step S04, and the step S06 are performed sequentially. In some embodiments, the step S04, the step S02, and the step S06 are performed sequentially. In some embodiments, the step S02 and the step S04 are performed simultaneously before the step S06 is performed.

With continuous reference to FIGS. 5 and 1, in some embodiments, the repairing method for the battery module 100 further includes the following steps. In the step S10, the connecting wire 150 is connected with the replacement cell assembly, so that the circuit board 140 is electrically connected with the replacement cell assembly. In the step S12, the conductive assembly 160 is connected with the replacement cell assembly, so that the replacement cell assembly is connected in series or in parallel with adjacent cell assemblies 130. In the step S14, the outer cover 120 is locked to the housing 110, so that all the cell assemblies 130 are accommodated in the chamber formed by the outer cover 120 and the housing 110. In some embodiments, the step S10 and the step S12 are performed simultaneously before the step S14 is performed. In some embodiments, the step S10 and the step S12 are performed simultaneously after the step S14 is performed.

With reference to FIGS. 5 and 3, the structure of the abnormal cell assembly 130A may refer to the structure of the cell assembly 130 (as shown in FIG. 3). In some embodiments, the abnormal cell assembly 130A is provided with a plurality of cells 1303; the repairing method for the battery module 100 further includes: when the step S08 is performed, the abnormal cell assembly 130A is separately taken out from the chamber, the abnormal cell 1303 is found among the plurality of cells 1303 of the abnormal cell assembly 130A, and the abnormal cell 1303 is replaced with the replacement cell 1303 to form a replacement cell assembly. Then, the replacement cell assembly is placed in the chamber. It should be noted that when one or more cells 1303 of the abnormal cell assembly 130A in the battery module 100 are abnormal or damaged, the abnormal cells 1303 may be separately taken out and replaced, while the normal cells 1303 may be kept in the cell assembly 130 for continued use.

With reference to FIGS. 5, 1, and 2, in some embodiments, the battery module 100 further includes a fixing post 170 that passes through the housing 110 and the abnormal cell assembly 130A for fixing the abnormal cell assembly 130A between the two side plates 1102. The repairing method for the battery module 100 further includes removing the fixing post 170 before the step S08 is performed. In this way, the connection between the abnormal cell assembly 130A and the housing 110 may be released, so that the abnormal cell assembly 130A may be taken out of the chamber alone.

In summary, the disclosure provides a battery module. When one or more cell assemblies in the battery module are abnormal or damaged, the battery module may be disassembled and only the abnormal or damaged cell assemblies may be taken out and replaced, while the normal cell assemblies may be kept in the battery module for continued use, which eliminates the need to replace the entire battery module and allows the battery module to be repaired and reused.

Although the disclosure has been described in considerable detail with reference to various embodiments, other embodiments are possible. Therefore, the spirit and scope of the appended claims should not be limited to the description of the embodiments contained herein.

It will be apparent to those skilled in the art that various modifications and variations can be made in the structure of the disclosure without departing from the scope or spirit of the disclosure. In view of the foregoing, it is intended that the disclosure cover modifications and variations of the disclosure that fall within the scope of the appended claims.

What is claimed is:

1. A battery module comprising:
a housing comprising:
a top plate; and
two side plates connected with opposite sides of the top plate respectively, wherein each of the side plates comprises a plurality of hollow windows arranged along a direction;
an outer cover covering the two side plates and forming a chamber with the housing;
a plurality of cell assemblies arranged in the chamber along the direction;
a circuit board arranged on the top plate;
a plurality of connecting wires electrically connected with the circuit board and the plurality of cell assemblies; and
a plurality of conductive assemblies corresponding to the positions of the plurality of hollow windows and electrically connected with two adjacent cell assemblies among the plurality of cell assemblies.

2. The battery module according to claim 1, wherein the plurality of connecting wires respectively pass through the plurality of hollow windows to be connected with the circuit board and the plurality of cell assemblies.

3. The battery module according to claim 1, wherein a top portion of each of the cell assemblies comprises a positioning protrusion, and the top plate of the housing comprises a plurality of positioning holes for respectively accommodating the plurality of positioning protrusions.

4. The battery module according to claim 1, wherein each of the conductive assemblies comprises:
a busbar, wherein each end of the busbar is provided with a through hole; and
two fixing members, used to lock the busbar to the two adjacent cell assemblies through the through holes.

5. The battery module according to claim 4, wherein the plurality of connecting wires is electrically connected with the plurality of cell assemblies through the plurality of fixing members respectively.

6. The battery module according to claim 4, wherein each of the cell assemblies comprises:
a cell support, accommodated with a plurality of cells; and
two conductive sheets respectively arranged on both sides of the cell support to be electrically connected with both ends of the plurality of cells, wherein the through hole passes through the conductive sheet and the cell support, and each of the fixing members is locked on the cell support through the through hole to be electrically connected with the busbar and the conductive sheet.

7. The battery module according to claim 1, further comprising at least one fixing post, which passes through the housing and the cell assembly for fixing the cell assembly between the two side plates.

8. A repairing method for the battery module according to any one of claim 1, comprising:
detecting an abnormal cell assembly among the plurality of cell assemblies;
removing the outer cover;
removing the connecting wire and the conductive assembly connected with the abnormal cell assembly; and
placing a replacement cell assembly after the abnormal cell assembly is taken out from the chamber.

9. The repairing method according to claim 8, further comprising:
finding an abnormal cell among a plurality of cells of the abnormal cell assembly; and
replacing the abnormal cell with a replacement cell to form the replacement cell assembly.

10. The repairing method according to claim 8, further comprising:
connecting the connecting wire with the replacement cell assembly;
connecting the conductive assembly with the replacement cell assembly; and
locking the outer cover to the housing.

11. The repairing method according to claim 8, wherein the battery module further comprises at least one fixing post passing through the housing and the abnormal cell assembly for fixing the abnormal cell assembly between the two side plates, and the repairing method further comprises: removing the at least one fixing post, before the abnormal cell assembly is separately taken out from the chamber and the replacement cell assembly is placed.
